(19) United States
(12) Patent Application Publication
(10) Pub. No.: US 2006/0132613 A1
(43) Pub. Date: Jun. 22, 2006

(54) Optical image stabilizer for camera lens assembly

(75) Inventors: Doo-Sik Shin, Suwon-si (KR); Dong-Sung Shin, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/122,641

(22) Filed: May 5, 2005

(30) Foreign Application Priority Data
Dec. 17, 2004 (KR) 2004-107855

(51) Int. Cl. H04N 5/228

(52) U.S. Cl. 348/208.7

(57) ABSTRACT

Disclosed is an optical image stabilizer for use with a camera lens assembly. The optical image stabilizer contributes to miniaturization of a camera lens assembly and improves solidity and reliability of a product with the camera lens assembly. The optical image stabilizer includes a base frame, a first frame on the base frame capable of moving in a first direction, a second frame on the first frame capable of moving in a second direction perpendicular to the first direction. The second frame is equipped on one side with an image sensor. The optical image stabilizer also includes a linear motor provided between the base frame and the first frame to move the first frame in the first direction, and a voice coil motor (VCM) for moving the second frame in the second direction. The linear motor and the VCM are disposed adjacently to each other.

### CLAIM OF PRIORITY

This application claims priority to an application entitled “Optical Image Stabilizer for Camera Lens Assembly,” filed in the Korean Intellectual Property Office on Dec. 17, 2004 and assigned Serial No. 2004-107855, the entire contents of which are hereby incorporated by reference.

### BACKGROUND OF THE INVENTION

1. Field of the Invention

The present invention relates to a camera device, and more particularly to an optical image stabilizer for use with a camera lens assembly.

2. Description of the Related Art

In general, both a charge coupled device (CCD) sensor and a complementary metal oxide semiconductor (CMOS) sensor are a kind of two-dimensional sensor for photographing a moving and static images. They are a key role in constructing an electronic camera. Particularly, the CCD sensor may provide better image quality characteristics than those of the CMOS sensor, but it has certain disadvantages. For example, the CCD sensor has a high power consumption and complicated structure. Thus, the CMOS image sensor has increased its market share and many attempts have been recently made to improve its image quality. With the progress of such image sensors, use of digital cameras is more wide spread. In addition, this progress of the image sensors has resulted in the production portable terminals, such as cellular phones, equipped with a camera device.

When a user takes photographs with an ordinary camera for photographing a moving image using either of such image sensors, unstable trembled images are frequently photographed. One source of the unstable images is due to trembling of the camera arising from external factors, such as the user's hand trembling and vibration of a camera mounted on a vehicle. In order to solve the problem of unstable images, several devices include an optical image stabilizer for compensating such movements. Such an optical image stabilizer includes a movement detecting unit and a movement compensating unit.

In the movement detecting unit, a method for predicting movements of a device by a Gyro Sensor or the like is used, as well as a method for detecting a moving portion of an image every frame by image signal processing. The problem of unstable images is solved and thus clear images are obtained by: (1) using a refractive lens (active prism) to optionally refract incident light or (2) controlling an input position of the image sensor based on the movement-related information detected by above-mentioned methods.

FIG. 1 is an exploded perspective view showing a partial construction of a prior art camera lens assembly. A conventional optical image stabilizer 100 is illustrated that solves the problem of unstable images by controlling an image input position of an image sensor 101.

As shown in FIG. 1, the conventional optical image stabilizer 100 is provided, on front and rear surfaces of the image sensor 101, with stages 102, 103. Stages 102 and 103 drive the image sensor 101 in a first direction X and a second direction Y, respectively so as to control an input position of the image sensor 101.

The stages 102, 103 include a fixable stage 102 and a movable stage 103.

The fixable stage 102 is equipped with a pair of first guides 121 on both its sides. The pair of first guides 121 face each other and extend in the first direction X parallel with each other. The movable stage 103 is coupled to the first guides 121 such that it can linearly move on the first guides 121, and so linearly reciprocates in the first direction X.

The movable stage 103 is equipped on both sides with a pair of second guides 131 on both its sides. The pair of second guides 131 face each other and extend in the second direction Y parallel With each other. The second direction Y is perpendicular to the first direction X. The image sensor 101 is coupled to the second guides 131 such that it can linearly move on the second guides 131, and so linearly reciprocates in the second direction Y.

Consequently, as the movable stage 103 moves in the first direction X, the image sensor 101 also moves in the first direction X while moving in the second direction Y on the movable stage 103 at the same time. In this manner, the conventional optical image stabilizer 100 structure (e.g. a pair of stages 102, 103 disposed on both sides of the image sensor 101) moves the image sensor 101 in two directions according to a user's hand trembling.

Disadvantageously, such a conventional optical image stabilizer limits the miniaturization of the camera lens assembly, due to the two stages on the image sensor. This is an obstacle to mounting such a camera lens assembly to a product which has difficulty in securing a space for packaging an additional component, such as a portable terminal. Moreover, when the conventional optical image stabilizers are simply downsized to an extent that it can be mounted to a desired product, it is difficult to ensure reliability against impacts caused by falling, etc.

### SUMMARY OF THE INVENTION

Accordingly, the present invention has been made to reduce or overcome the above-mentioned problems occurring in the prior art and provides additional advantages, by providing an optical image stabilizer for use with a camera lens assembly, which facilitates miniaturization of a product that is equipped with the camera lens assembly.

Another aspect of the present invention is to provide an optical image stabilizer for a camera lens assembly, which ensures solidity and reliability of a product that is equipped with a camera lens assembly while facilitating miniaturization of the product.

In one embodiment, there is provided an optical image stabilizer for use with a camera lens assembly, the optical image stabilizer comprising: a base frame; a first frame on the base frame capable of moving in a first direction; a second frame on the first frame capable of moving in a second direction perpendicular to the first direction; an image sensor on one side of the second frame; a linear motor between the base frame and the first frame to enable movement the first frame in the first direction; and a voice coil motor (VCM) adjacent to the linear motor, wherein the VCM enables movement of the second frame in the second direction.

### BRIEF DESCRIPTION OF THE DRAWINGS

The present invention will be more apparent from the following detailed description taken in conjunction with the accompanying drawings, in which:

FIG. 1 is an exploded perspective view showing a partial construction of a camera lens assembly according to one example of the prior art;

FIG. 2 is a perspective view showing a camera lens assembly with an optical image stabilizer in accordance with an embodiment of the present invention;

FIG. 3 is an exploded perspective view showing the optical image stabilizer for a camera lens assembly shown in FIG. 2;

FIG. 4 is an exploded perspective view showing how a base frame and a first frame of the optical image stabilizer shown in FIG. 3 are coupled to each other;

FIG. 5 is a side view showing how a second guide shaft is coupled to the first frame of the optical image stabilizer shown in FIG. 3;

FIG. 6 is an exploded perspective view showing how yokes, a magnetic body and so forth are attached to the base frame of the optical image sensor shown in FIG. 3;

FIGS. 7 and 8 are plan views showing partial constructions of the optical image stabilizer shown in FIG. 3, respectively;

FIG. 9 is a lateral sectional view of the optical image stabilizer cut along line A-A′ in FIG. 7; and

FIG. 10 is a block diagram for explaining operations of the optical image stabilizer.

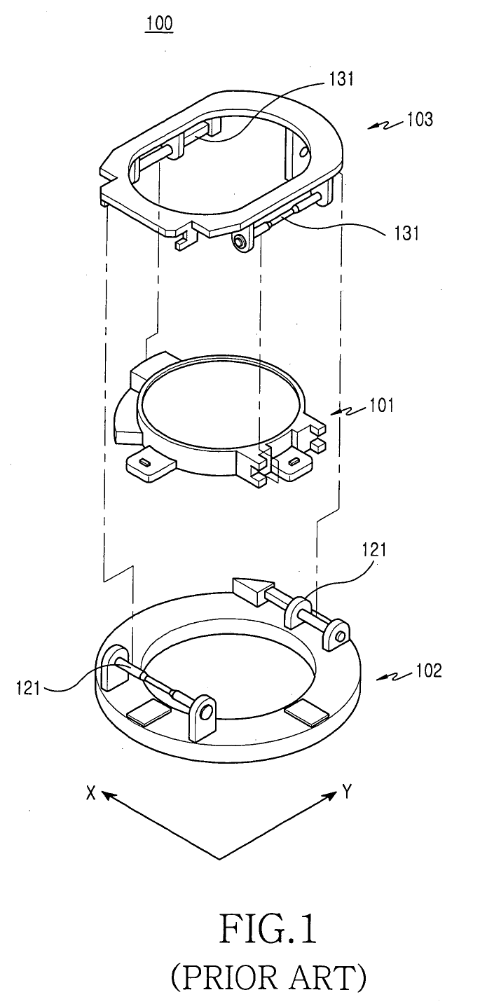

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

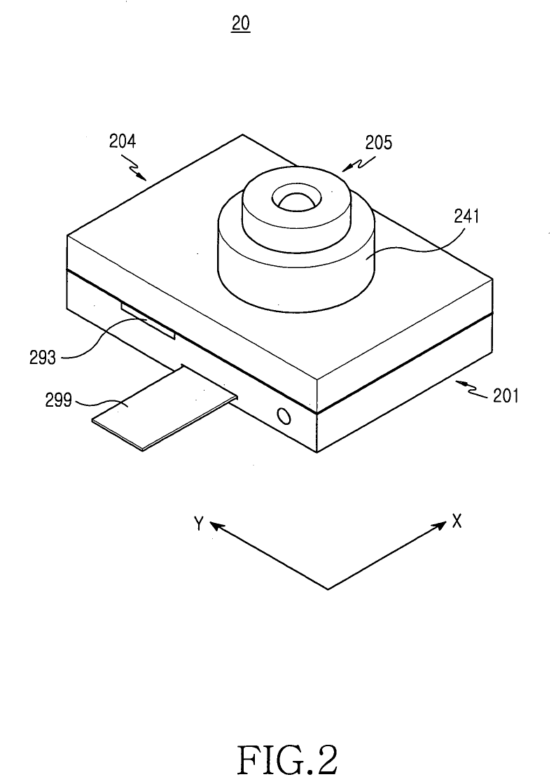

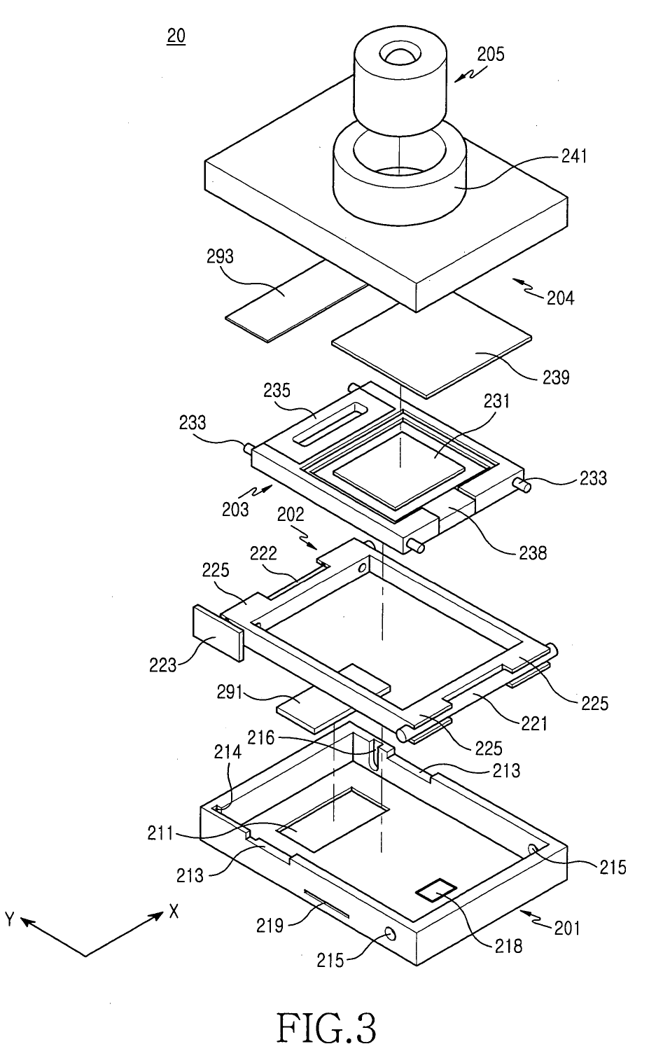

FIG. 2 is a perspective view showing a camera lens assembly 20 with an optical image stabilizer 200 in accordance with a preferred embodiment of the present invention. FIG. 3 is an expanded perspective view showing the optical image stabilizer 200 shown in FIG. 2. As shown in the drawings, the optical image stabilizer 200 in accordance with this embodiment includes a base frame 201, a first frame 202, a second frame 203, and a housing 204 with a lens assembly 205 coupled thereto. The optical image stabilizer 200 is attached to the base frame 201 to thereby form the camera lens assembly 20.

The base frame 201 is constructed to accommodate the first and second frames 202, 203, and is opened on its upper surface.

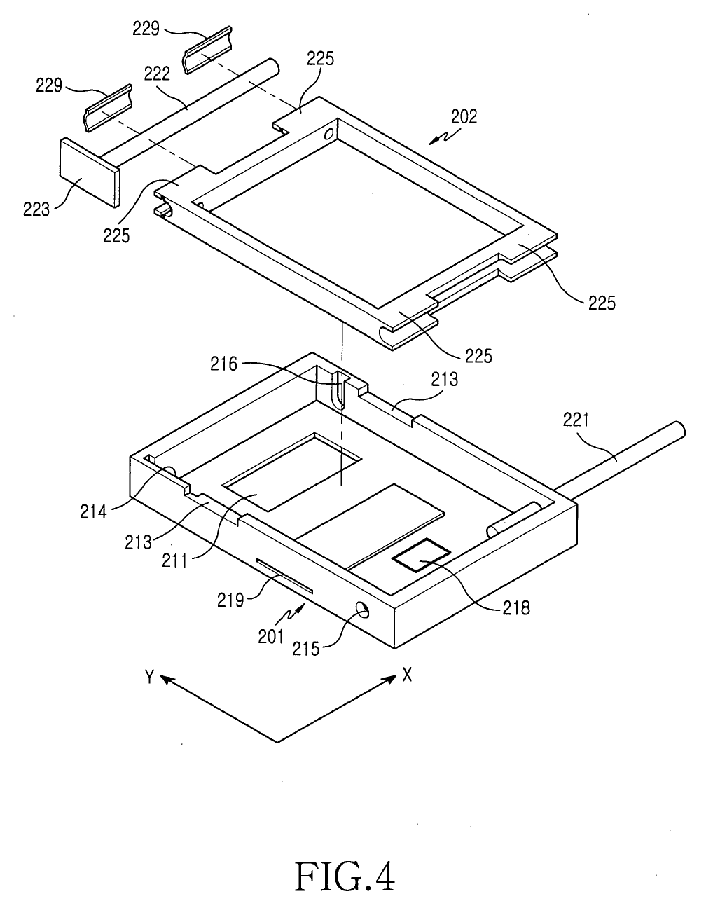

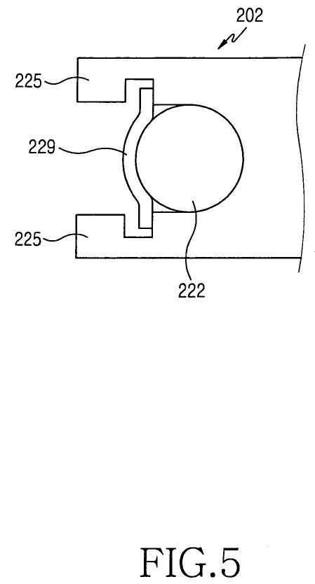

As shown in FIGS. 4 and 5, the first frame 202 is received in the base frame 201 and can move a first direction X, for example slide, glide and the like. First and second guide shafts 221, 222 extending in the first direction X are coupled to both inner ends of the base frame 201, respectively.

The first guide shaft 221 is fixed at its both ends to inner walls of one end portion of the base frame 201. One end portion of the first frame 202 is slidingly coupled onto the first guide shaft 221. More particularly, the first frame 202 is provided with at least a coupling piece at its one end portion, preferably a pair of coupling pieces 225. The coupling piece(s) surroundingly engage an outer circumferential surface of the first guide shaft 221.

In order to fix the first guide shaft 221, the inner walls of one end portion of the base frame 201 are formed with a pair of coupling holes 215. The pair of coupling holes 215 are preferably opposite to each other.

Although a description of the this embodiment is given with respect to a construction in which the first guide shaft 221 is fixed to the base frame 201, and the first frame 202 is slidingly coupled onto the first guide shaft 221, those skilled in the art will recognize other arrangements are possible. For example, it is possible to fix the first frame 202 and the first guide shaft 221 to each other, and slidingly couple the first guide shaft 221 to the base frame 202.

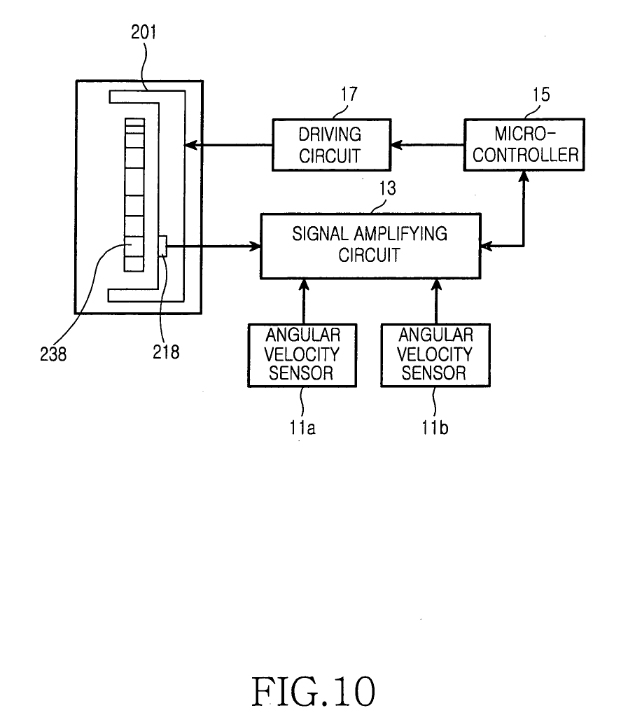

A linear motor 223 is connected to one end of the second guide shaft 222. The other end of the second guide shaft 222 is slidingly coupled to a sliding hole 216 formed in the base frame 201. The linear motor 223 connected to one end of the second guide shaft 222 is positioned within a fixing groove 214 formed in an inner wall of the other end of the base frame 201. A piezoelectric element, an ultrasonic motor or the like may be used as the linear motor 223. A signal from an external driving circuit 17 (shown in FIG. 10) is applied to the linear motor 223 to vibrate the linear motor 223 and thus the second guide shaft 222 in the first direction.

The other end portion of the first frame 202 is formed with at least a coupling piece, preferably a pair of coupling pieces 225. The coupling piece(s) surround a part of an outer circumferential surface of the second guide shaft 222. Plate springs 229 are fitted into the coupling pieces 225, respectively to press the outer circumferential surface of the second guide shaft 222.

Here, the linear motor 223 is vibrated pursuant to an applied signal. but the linear motor 223 moves rapidly in one direction and slowly in the other direction. The linear motor 223 also alternately repeats such rapid and slow motions. Directions of the rapid and slow motions are determined by polarity of the signal applied to the linear motor 223.

When the rapid motion of the linear motor 223 progresses, only the second guide shaft 222 moves in either direction while the first frame 202 is stopped. This is because a friction force between the plate spring 229 and the outer circumferential surface of the second guide shaft 222 is smaller than an inertia force of the first frame 202. When the linear motor 223 conducts the slow motion, the first frame 202 comes to move together with the second guide shaft 222. This is caused by a static friction force between the plate spring 229 and the second guide shaft 222. Thus, if the same signal continues to be applied to the linear motor 223, the first frame 202 moves toward one side in the first direction X. Similarly, if a signal having different polarity is applied to the linear motor 223, the first frame 202 moves toward the other side in the second direction Y.

The second frame 203 is coupled to the first frame 201. For example in this embodiment, it is encompassed by the first frame 202, and freely moves in a second direction Y perpendicular to the first direction X within the first frame 202. An image sensor 231 is mounted on an upper surface of the second frame 203 while facing an inner surface of the housing 204. The lens assembly 205 is aligned on an optical axis of the image sensor 205. An infrared filter 239 is mounted between the lens assembly 205 and the image sensor 231 on the second frame 203. The infrared filter 239 intercepts light except for visible ray, thereby improving quality of photographed images. A flexible printed circuit 299 connected to the image sensor 231 extends through a slit 219 formed on one side of the base frame 201.

In order to guide the free movements of the second frame 203, a pair of third guide shafts 233 extending in the second direction Y are penetratingly joined to both lateral ends of the second frame 203, respectively. The third guide shafts 233 are fixed at their both ends to an inner wall of the first frame 202. The second frame 203 freely moves in the second direction on the first frame 202 while guided by the third guide shafts 233.

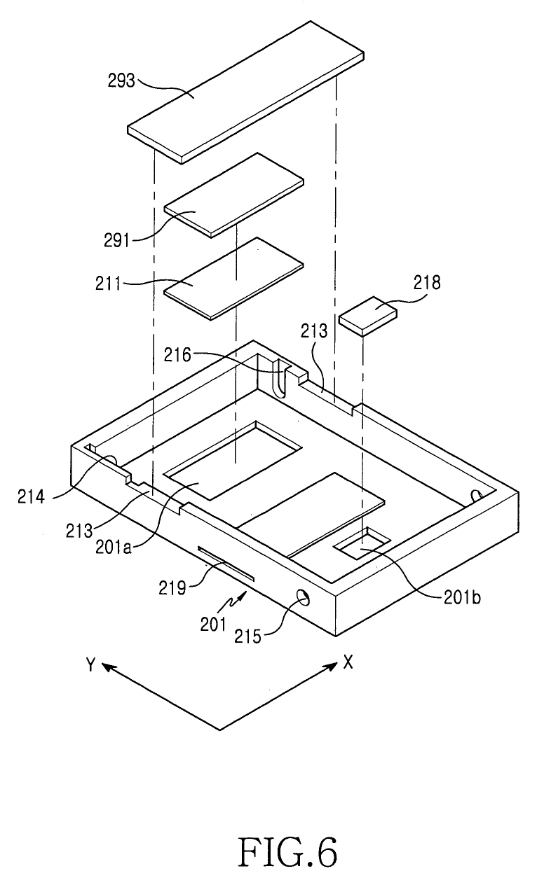

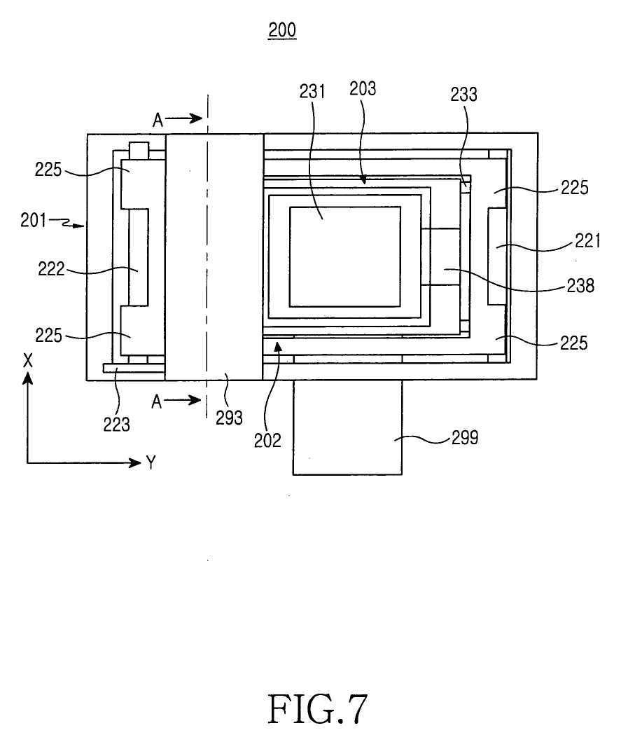

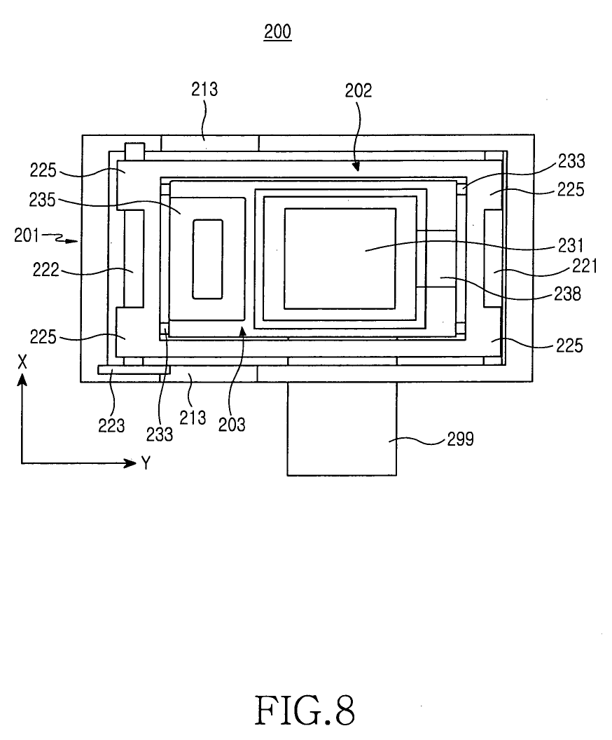

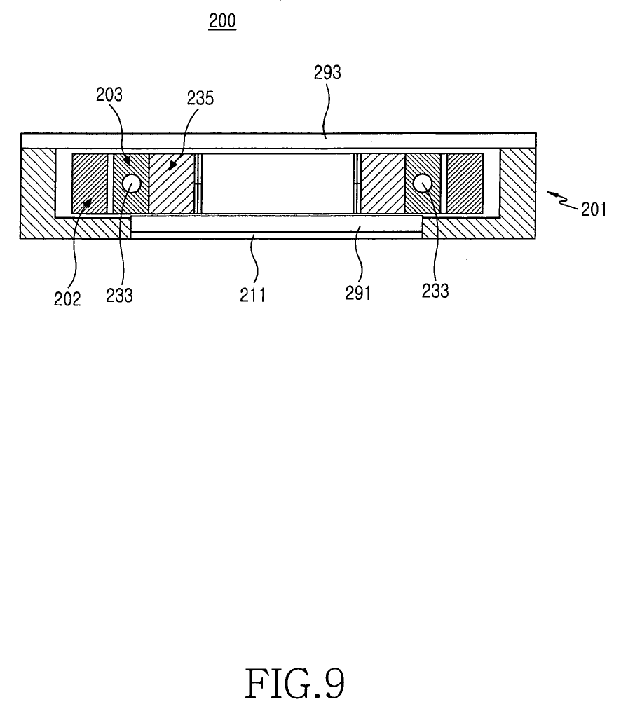

Further referring to FIG. 6, a voice coil motor (VCM) may be used as driving means of the second frame 203. To construct the VCM, a solenoid coil 235 is mounted to the second frame 203, and a pair of yokes 291, 293 and a magnetic body 211 are attached to the base frame 201.

The solenoid coil 235 is attached to one end of the second frame 203 to generate an electric field when an electrical current is applied. The electric field generated from the solenoid coil 235 causes the second frame 203 to freely move in the second direction Y by interaction with a magnetic field of the magnetic body 211.

The magnetic body 211 and a lower yoke 291 are attached on a seating surface 201a formed on an inner side of the base frame 201 to form a laminate structure. An upper yoke 293 is attached to an upper end of the base frame 201. The lower and upper yokes 291, 293 face the solenoid coil 235, respectively. The solenoid coil 235 is situated within the magnetic field of the magnetic body 211.

The second frame 203 freely moves in the second direction Y by the VCM as noted above, and simultaneously the first frame 202 freely moves in the first direction X by the linear motor 223. Consequently, the second frame 202 is constructed such that it can freely move in the first and second directions X, Y, respectively.

Preferably, the piezoelectric element 223 and the VCM are disposed such that they operated in adjacent positions to each other, so that spaces occupied by the components for driving the first and second frames 202, 203 are minimized.

In the meantime, the optical image stabilizer 200 is provided with a position detector in order to monitor positional change of the second frame 203, in particular, the image sensor 231. The position detector includes a light emitting diode 238 and a photo diode 218. The light emitting diode is provided on the second frame 203. The photo diode 218 is provided on the base frame 201 to sense light exited from the light emitting diode 238. The light emitting diode 238 can freely move together with the second frame 203, and the photo diode 218 is fixed to a groove 201b formed in the base frame 201. As the second frame 203 freely moves, the positional change of the second frame 203 is sensed from change of light detected by the photo diode 218.

The camera lens assembly 20 with the optical image stabilizer 200 constructed as noted above is mounted to a digital camera, a portable terminal and so forth. Miniaturization is possible since the camera lens assembly 20 corrects unstable images arising from external vibration such as hand trembling by driving not the lens, but the image sensor 231. This is handily utilized in the case of mounting a camera device to a portable terminal.

FIG. 10 is a block diagram of the optical image stabilizer 200. Operationally, the optical image stabilizer 200 is controlled by a pair of angular velocity sensors 11a, 11b, a signal amplifying circuit 13, a microcontroller 15 and a driving circuit 17. Each of the pair of angular velocity sensors 11a, 11b sense hand trembling, etc. in the first and second directions X, Y. The signal amplifying circuit 13 amplifies a signal detected from the angular velocity sensors 11a, 11b. The photo diode 218 supplies the amplified signal to the microcontroller 15. The microcontroller 15 calculates a driving amount, a driving direction, etc. to deliver to the driving circuit 17. On this basis the driving circuit 17 drives the optical image stabilizer 200.

As described above, in the optical image stabilizer for a camera lens assembly according to the present invention, contributes to miniaturization of a camera lens assembly. In particular, frames for disposing an image sensor, a linear motor and a voice coil motor for driving the frames and the like are constructed such that they are all accommodated in one base frame. Such a miniaturized camera lens assembly can be easily packaged in a camera or a portable terminal. In addition, since the miniaturized camera lens assembly provides extra spaces, it is possible to realize various designs of a camera or a portable terminal. Furthermore, the optical image stabilizer for a camera lens assembly has a simple and compact structure, thereby improving solidity and reliability of a product such as a camera or a portable terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical image stabilizer for use with a camera lens assembly, comprising:
a base frame;
a first frame on the base frame capable of moving in a first direction;
a second frame on the first frame capable of moving in a second direction perpendicular to the first direction;
an image sensor on one side of the second frame;
a linear motor between the base frame and the first frame to enable movement of the first frame in the first direction; and
a voice coil motor (VCM) adjacent to the linear motor, wherein the VCM enables movement of the second frame in the second direction.

2. The optical image stabilizer as claimed in claim 1, wherein the linear motor is a piezoelectric element.

3. The optical image stabilizer as claimed in claim 1, wherein the VCM comprises:
a solenoid coil at one lateral end of the second frame,
a pair of yokes on the base frame and facing upper and lower surfaces of the solenoid coil, respectively; and
a magnetic body between the base frame and the yoke facing the lower surface of the solenoid coil.

4. The optical image stabilizer as claimed in claim 3, wherein an upper surface of the base frame is opened, one yoke is attached to an inner lower surface of the base frame, and the other yoke is attached at its both ends to an upper side of the base frame.

5. The optical image stabilizer as claimed in claim 3, wherein a magnetic field is generated between the magnetic body and the yoke attached to the upper side of the base frame, and the magnetic field interacts with an electric field generated by the solenoid coil to move the second frame.

6. The optical image stabilizer as claimed in claim 1, further comprising a first guide shaft secured on the base frame and having one end slidingly coupled to the first frame is slidingly coupled; a second guide shaft having one end coupled to the linear motor, and having another end slidingly supported on the base frame and another end of the first frame is slidingly coupled; and at least a plate spring secured on the first frame to press outer circumferential surface of the second guide shaft, wherein a friction force between the plate spring and the second guide shaft is smaller than an inertia force of the first frame when the second guide shaft rapidly moves by the operation of the linear motor, and the first frame move together with the second guide shaft by a static friction force between the plate spring and the second guide shaft when the second shaft slowly moves by the operation of the linear motor.

7. The optical image stabilizer as claimed in claim 6, further comprising at least a pair of coupling pieces formed at both end of the first frame, respectively and surroundingly coupled to outer circumferential surfaces of the first and second guide shafts.

8. The optical image stabilizer as claimed in claim 1, further comprising a pair of third guide shafts secured on the first frame, respectively and to outer circumferential surface of which both ends of the second frame is slidingly coupled.

9. The optical image stabilizer as claimed in claim 8, wherein the third guide shafts are penetratingly coupled to both ends of the second frame in the second direction.

10. The optical image stabilizer as claimed in claim 1, further comprising an infrared filter attached adjacently to an upper surface of the image sensor.

11. The optical image stabilizer as claimed in claim 1, further comprising a housing coupled to an upper portion of the base frame; and lens assembly coupled on the housing while aligned on an optical axis of the image sensor and including at least a lens.

12. The optical image stabilizer as claimed in claim 1, further comprising a light emitting diode provided at the other end of the second frame; and a photo diode provided on the base frame and facing the light emitting diode, wherein the photo diode senses light exited from the light emitting diode to detect positional change of the second frame relative to the base frame.

13. The optical image stabilizer as claimed in claim 12, further comprising angular velocity sensors provided on a camera to mount the camera lens assembly, and to measure changes in angular velocities in the first and second directions, respectively and thereby detect the amount of a user's hand trembling, wherein the linear motor and the VCM are driven using the changes in angular velocity and the positional change of the second frame relative to the base frame, detected from the light emitting diode and the photo diode.
